(19) United States
(12) Patent Application Publication
(10) Pub. No.: US 2003/0076276 A1
(43) Pub. Date: Apr. 24, 2003

(54) Methods and systems for embedding electrical components in a device including a frequency responsive structure

(76) Inventors: Kenneth H. Church, Stillwater, OK (US); Robert M. Taylor, Perkins, OK (US); Michael John Wilhelm, Stillwater, OK (US); Douglas H. Werner, State College, PA (US); Pingjuan L. Werner, State College, PA (US)

Correspondence Address: NEEDLE & ROSENBERG, P.C., Suite 1200, The Candler Building, 127 Peachtree Street, N.E., Atlanta, GA, 30303-1811, US

(21) Appl. No.: 10/188,909

(22) Filed: Jul. 2, 2002

Related U.S. Application Data
(63) Continuation-in-part of application No. 10/072,739, filed on Feb. 8, 2002.
(60) Provisional application No. 60/267,146, filed on Feb. 8, 2001.
(60) Provisional application No. 60/349,185, filed on Jan. 15, 2002.
(60) Provisional application No. 60/302,375, filed on Jul. 3, 2001.

(51) Int. Cl. H01Q 15/02; H01Q 15/24

(52) U.S. Cl. 343/909

(57) ABSTRACT

Methods and systems are provided for embedding electrical components within a device including a frequency responsive structure, such as an antenna or a frequency selective surface. Electrical components are selected and locations for placing the selected components within the device are selected for optimizing performance characteristics of the structure. The selection may be performed by modeling the device with various electrical components embedded at various locations using, for example, a genetic algorithm. The selected components are embedded at the selected locations. The frequency responsive structure and the selected components embedded at the selected locations may be produced in the same manufacturing process. The selected electrical components may be embedded at the selected locations as contiguous and integral parts of the device and may be embedded within the frequency responsive structure. The selected components may also be embedded at the selected locations on a surface of a substrate opposite the surface on which the frequency responsive surface is supported. The frequency response of the structure may be tuned by adapting the electrical components.

### CROSS REFERENCE TO RELATED APPLICATIONS

This application is a Continuation-in-part of U.S. patent application Ser. No. 10/072,739 filed on Feb. 8, 2002, which itself claims priority from commonly assigned U.S. Provisional Patent Application No. 60/267,146, filed on Feb. 8, 2001, and U.S. Provisional Patent Application No. 60/349,185, filed on Jan. 15, 2002. These applications are hereby incorporated by reference. In addition, this application claims the benefit of U.S. Provisional Application No. 60/302,375 filed Jul. 3, 2001, which is hereby incorporated by reference.

### BACKGROUND

The present invention is directed to methods and systems for embedding electrical components in a device including a frequency responsive structure. In particular, the present invention is directed to methods and system for embedding electrical components into a device including a frequency responsive structure to optimize performance characteristics.

In frequency responsive structures such as antennas, it is often desirable to be able to achieve multiband frequencies. The frequency band is divided and allocated for specific tasks. A single antenna capable of achieving multi-antenna response, such as a dual-band antenna, reduces space requirements for antennas. Multiband antennas are typically made by using resonator loads to modify the resonance of the antenna.

This approach can also provide broadband effects. Broadband and extreme broadband antennas are typically built using antenna arrays or specific antenna geometries approach. The embedded components enable broadband characteristics and reduce the space required by the antenna.

Embedded components have also been used to provide enhancements in gain, match impedance, reduce reflections in S11 measurement and improve other electrical characteristics of the antenna.

Techniques have been proposed for embedding passive components in devices that include antennas to improve the frequency response. However, these techniques typically use soldering to connect passive components such as inductors and capacitors to the antenna structure. The soldered passive electrical components are not contiguous with the antenna structure. At the joints between the solder and the components and between the solder and the structure, losses occur. Also, the soldering of the electrical components makes the structure not structurally sound and requires numerous steps in manufacturing. In addition, the size of the substrate supporting the structure must be large enough to accommodate the soldered electrical components. This adds to the size of the device.

Another problem with embedding components into a device involves determining where to place the components. In the past, locations for embedding the components were chosen, and, depending upon the performance characteristics, the locations were varied as necessary. This “trial and error approach” is cumbersome and does not guarantee that the resulting structure has desired radiation characteristics but rather typically results in a design that is suboptimal.

Thus, there is a need for a technique for embedding electrical components within a device including a frequency responsive structure in a simple, efficient, and accurate manner that enhances performance characteristics of the structure while minimizing the size of the device.

### SUMMARY

It is therefore an object of the present invention to provide a technique for embedding components within a device including a frequency responsive structure in a simple, efficient, and accurate manner that enhances the performance characteristics of the structure while minimizing the size of the device.

According to an exemplary embodiment, this and other objects are met by methods and systems for embedding electrical components within a device including a frequency responsive structure, such as an antenna or a frequency selective surface. Electrical components are selected and locations for placing the selected components within the device are selected for optimizing performance characteristics of the structure. These selections may be performed by modeling the device with various electrical components embedded at various locations using, e.g., a genetic algorithm. The selected components are embedded at the selected locations. The frequency responsive structure and the selected components embedded at the selected locations may be produced in the same manufacturing process.

According to one embodiment, the selected electrical components are embedded at the selected locations as contiguous and integral parts of the device, e.g., within the frequency responsive structure.

According to another embodiment, the selected components are embedded at the selected locations on a surface of a substrate opposite the surface on which the frequency responsive surface is supported.

According to one embodiment, the frequency response of the structure may be tuned by adding and/or subtracting material from the device. According to another embodiment, tuning may be achieved by adjusting the electrical components.

The objects, advantages and features of the present invention will become more apparent when reference is made to the following description taken in conjunction with the accompanying drawings.

### BRIEF DESCRIPTION OF THE DRAWINGS

FIGS. 1 and 2 illustrate an exemplary device including components embedded within an antenna;

FIG. 3 illustrates an actual prototype including an embedded inductor and capacitor written in line with an antenna to provide a dual band antenna; and

FIG. 4 illustrates an exemplary method for embedding electrical components.

### DETAILED DESCRIPTION

According to an exemplary embodiment, methods and systems are provided for producing devices including frequency responsive structures with enhanced performance characteristics that are small in comparison to conventional devices.

For simplicity of illustration, the description below is directed largely to an antenna. However, it will be appreciated that the invention is not limited to antennas but is applicable to any device including a frequency responsive structure.

Typical models of antennas comprise a variation of electrical components, such as capacitors and inductors, arranged in series and in parallel. According to exemplary embodiments, these components may be embedded into the device in a contiguous and integral manner, e.g., into the metallic conductors of the antenna, in strategically placed locations, forcing different electrical characteristics. These new electrical characteristics can be modeled and predicted before fabricating the device, thus creating new desired electrical effects.

According to an exemplary embodiment, electrical components may be embedded within a device including a frequency responsive surface, such an antenna, as integral and contiguous parts of the device. Any contiguous and integral embedding process may be used to embed the components either within the frequency responsive surface or within the substrate supporting the surface. These processes may include but are not limited to direct writing, screen printing, stamping, lithography, and electroplating. Once the configuration for embedding the components is determined, these processes may be performed by conventional devices.

The electrical components may include any combination of linear passive components, such as capacitors, inductors, resistors, transistors (bipolar or field effect), nonlinear passive components, such as varicaps, varactors, and varactor diodes, and active components, such as negative impedance, fractional impedance, and higher-order impedance loads. These components enhance performance characteristics such as the antenna gain, frequency response, bandwidth, and loading characteristics and may be used to provide multiband tunability.

The electrical components may also include a balun structure and a matching network. A balun network is a transforming circuit that allows a balanced transmission line to efficiently drive an unbalanced antenna structure. The balun configuration as well as the matching network topology and associated component values may be optimized simultaneously with the antenna geometry and loads.

According to exemplary embodiments, the loaded antenna structure may be modeled before fabrication to determine the components and placement of components within the device that produce optimal performance characteristics. Modeling may be performed using, e.g., a genetic algorithm as described in the afore-mentioned copending U.S. patent application Ser. No. 10/072,739. The genetic algorithm may be applied to determine the pattern of the antenna and the electrical components that produce optimal performance characteristics.

According to exemplary embodiments, the performance of the frequency responsive surface may be fine-tuned by adapting the material of the device. According to one embodiment, the tuning may be performed by adding and/or subtracting material from the device. Material may be added to or subtracted from, e.g., the electrical components and/or the frequency responsive structure. The additive process may include using a contiguous and integral additive process, such as direct writing, screen printing, stamping, lithography, or electroplating. The additive process may also include other processes such as wire bonding, conductive gluing, soldering or any other additive process to add conductor material, resistor material, dielectric material, or ferrite material sufficient to alter the capacitance, resistance, inductance, or any combination of the aforementioned properties for optimal tuning of the antenna structure. The subtractive process may include using a cutting laser or other subtractive techniques such as scraping or chemical or ion beam etching, to remove conductor material, resistor material, dielectric material, or ferrite material, or any combination of the aforementioned materials sufficient to alter the capacitance, resistance or inductance for optimal tuning of the antenna structure. The additive and subtractive processes may be performed before forming the antenna, as part of the fabrication of the antenna, or after forming the antenna. Also, these processes may be modeled in advance

According to another embodiment, electrically adjustable components, such as varactors, may be used as the electrical components. Once these components are embedded, fine-tuning may be accomplished by adjusting these components.

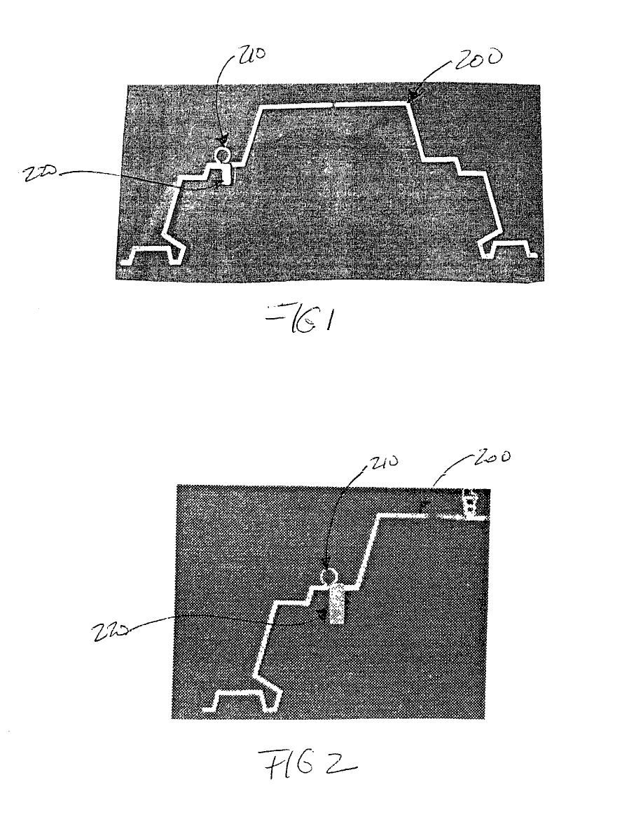

FIGS. 1 and 2 illustrate an exemplary device including an antenna and embedded components. In these figures, passive components 210 and 220 are embedded in line with the metallic shape 200 that forms the antenna. The antenna 200 and components 210 and 220 may be fabricated in one manufacturing process. A close up of the embedded components, the inductor and capacitor, is shown in FIG. 2B. The inductor is the metallic loop 210, while the capacitor is the layered and rectangular shape 220.

Although in FIGS. 1 and 2, the electrical components are embedded in line with the antenna pattern, it will be appreciated that the invention is not limited to this type of configuration. The electrical components may also be applied to the substrate that supports the antenna or to the antenna itself, using any contiguous and integrated embedding technique, such as those described above.

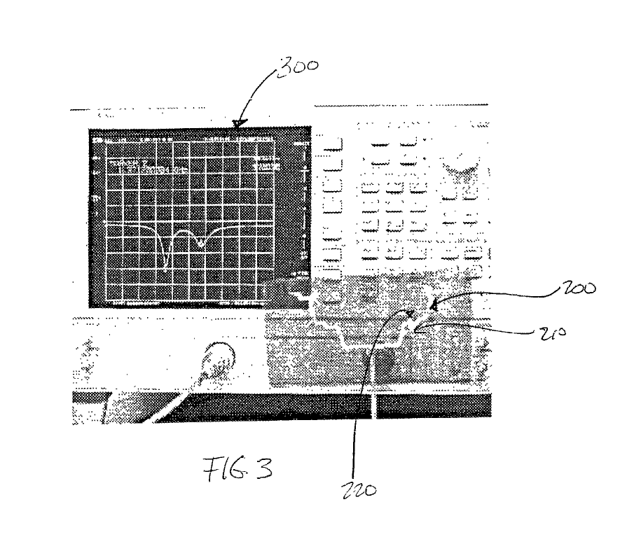

FIG. 3 illustrates a prototype of the antenna 200 with embedded components 210 and 220 that was actually fabricated and tested. The antenna was designed to be a dual band antenna, and an inductor and a capacitor were embedded for this purpose. As shown on the oscilloscope 300 in FIG. 3, the antenna produced a dual band frequency response. As can be seen from this figure, the electrical characteristics were altered by embedding the passive components as predicted.

Although the descriptions above relates mainly to individual antennas, it will be appreciated that the invention is not so limited. Electrical components may also be strategically selected and placed within a device including an antenna array.

Also, in addition to antenna applications, the electrical components may be selected and placed within a device including a frequency selective surface (FSS). Components may be embedded directly within the FSS and/or on the substrate supporting the FSS in a contiguous and integral manner. Also, the components may be embedded within the device on the surface of the substrate opposite the surface supporting the FSS, either in a contiguous and integral manner or using some other embedding technique, such as wire bonding, conductive gluing or soldering. All of these configurations minimize the size of the device including the FSS and allow enhancement and control of the electrical characteristics.

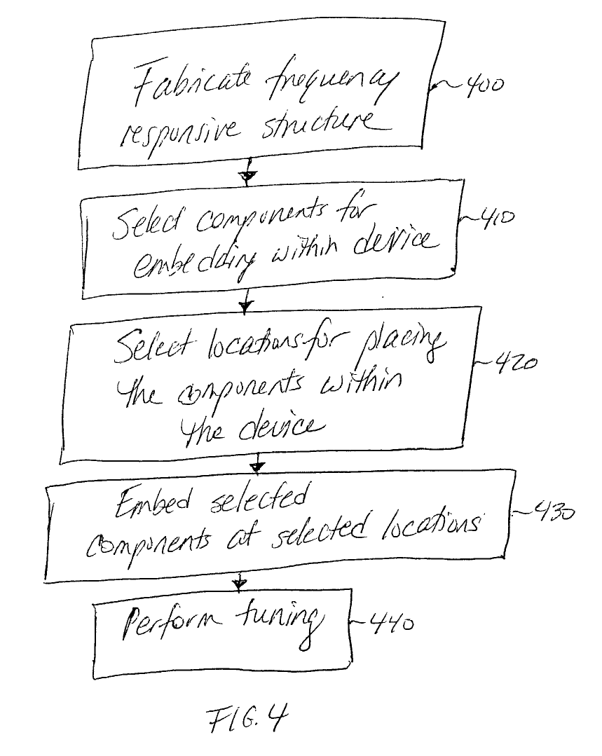

FIG. 4 illustrates an exemplary method for embedding electrical components within a device including a frequency responsive surface according to exemplary embodiments. The method begins at step 400 at which a frequency responsive structure is fabricated. This step may include selecting a configuration for the frequency responsive structure using, e.g., a genetic algorithm as described in the copending U.S. patent application Ser. No. 10/072,739. At step 410, electrical components are selected for embedding in the device. At step 420, locations for placing the electrical components within the device are selected. Steps 410 and 420 may be performed using, e.g., a genetic algorithm. At step 430, the selected components are embedded at the selected locations. For a device including an antenna, the electrical components may be embedded in a contiguous and integral manner within, e.g., the antenna or the substrate supporting the antenna. For a device including an FSS, the electrical components may be embedded in a contiguous and integral manner within, e.g., the FSS or the substrate supporting the FSS. Alternatively, the components may be embedded on the surface of the substrate opposite the surface supporting the FSS using any embedding technique. At step 440, the frequency responsive structure is fined tuned, e.g., by an additive and/or subtractive process or by adjusting the electrical components.

Although shown as separate steps, one or more of the steps in FIG. 4 may be performed at the same time. For example, the configuration for the frequency responsive structure may be selected at the same time as the electrical components and the locations for embedding the electrical components. The structure including the frequency responsive structure and the embedded components may be fabricated at one time, in the same manufacturing process. Also, the additive and/or subtractive processes may be performed before, during, or after fabrication of the frequency selective surface.

According to exemplary embodiments, methods and systems are provided for producing frequency responsive structures, such as antennas and FSS's that are smaller and have improved electrical characteristics in comparison with conventional devices. Electrical components may be embedded as continuous and integral parts of the device, e.g., within the frequency responsive structure or on the substrate supporting the frequency responsive structure. Alternately, these components may be embedded on a surface of a substrate opposite the surface supporting the frequency responsive structure using any embedding technique. The embedded components force specified and designed electrical effects, thus enhancing and controlling the electrical performance of the frequency responsive structure.

It should be understood that the foregoing description and accompanying drawings are by example only. A variety of modifications are envisioned that do not depart from the scope and spirit of the invention.

The above description is intended by way of example only and is not intended to limit the present invention in any way.

What is claimed is:

1. A method for producing a device including a frequency responsive structure with optimal performance characteristics, comprising the steps of:
selecting electrical components for embedding as integral and contiguous parts of the device for optimizing performance characteristics of the structure; and
selecting locations within the device for embedding the selected components as integral and contiguous parts of the device and for optimizing performance characteristics of the structure.

2. The method of claim 1, further comprising embedding the selected components at the selected locations as contiguous and integral parts of the device.

3. The method of claim 1, wherein the step of selecting selects locations within the frequency selective surface for embedding the selected components.

4. The method of claim 3, wherein the frequency responsive structure comprises a pattern of materials, and the method further comprises embedding comprises embedding the electrical components within the pattern of materials in a manner that makes the electrical components part of the pattern.

5. The method of claim 1, wherein the frequency responsive structure comprises an antenna.

6. The method of claim 1, wherein the frequency responsive structure comprises a frequency selective surface.

7. The method of claim 1, wherein the components and the locations are selected for embedding using at least one process in a group of contiguous and integrated embedding processes including direct writing, screen printing, stamping, lithography, and electroplating.

8. The method of claim 1, wherein the step of selecting electrical components comprises modeling the device with various electrical components embedded therein and determining the electrical components that result in optimal performance characteristics, and the step of selecting locations for placing the electrical components comprises modeling the device with electrical components embedded at various locations and determining the locations for placing the electrical components that result in optimal performance characteristics.

9. The method of claim 8, wherein the steps of modeling are performed using a genetic algorithm.

10. The method of claim 1, wherein the electrical components are part of an impedance matching network.

11. The method of claim 1, wherein the performance characteristics enhanced include at least one of gain, frequency response, bandwidth, and loading.

12. The method of claim 1, wherein the electrical components provide the frequency responsive structure with multiband capabilities.

13. The method of claim 1, further comprising tuning a frequency response of the structure by adding material to or subtracting material from the device or performing a combination of adding material to and subtracting material from the device.

14. The method of claim 13, wherein the step of tuning adds material to or subtracts material from the frequency responsive structure or electrical components embedded within the device.

15. The method of claim 13, wherein the step of subtracting includes performing at least one process in a group of subtraction processes including laser trimming, chemical etching, ion beam etching, and scraping.

16. The method of claim 13, wherein the step of adding includes performing at least one process in a group of addition processes including direct writing, screen printing, stamping, lithography, electroplating, wire bonding, conductive gluing and soldering.

17. The method of claim 1, wherein the step of selecting electrical components comprises selecting electrically adjustable components, and the method further comprises tuning a frequency response of the structure by electrically adjusting the selected components.

18. A method for producing a device including a frequency responsive structure with optimal performance characteristics, the method comprising the steps of:
selecting electrical components for optimizing performance characteristics of the frequency responsive structure;
selecting locations within the device for placing the selected components for optimizing performance characteristics of the structure; and
producing the device, including the frequency responsive structure and the selected electrical components placed at the selected locations, wherein the frequency responsive structure and the selected electrical components are formed in the same manufacturing process.

19. The method of claim 18, wherein the frequency responsive structure comprises a pattern of materials with the selected electrical components embedded therein.

20. The method of claim 18, wherein the frequency responsive structure is supported by one surface of a substrate included in the device, and the electrical components are supported by another surface of the substrate.

21. The method of claim 18 wherein the frequency responsive structure comprises an antenna.

22. The method of claim 18, wherein the frequency responsive structure comprises a frequency selective surface.

23. The method of claim 18, wherein the manufacturing process includes performing at least one process in a group of contiguous and integrated manufacturing processes including direct writing, screen printing, stamping, lithography, and electroplating.

24. The method of claim 18, wherein the step of selecting electrical components comprises modeling the device with various electrical components included therein and determining the electrical components that result in optimal performance characteristics, and the step of selecting locations for placing the electrical components comprises modeling the device with electrical components placed at various locations therein and determining the locations for placing the electrical components that result in optimal performance characteristics.

25. The method of claim 24, wherein the steps of modeling are performed using a genetic algorithm.

26. The method of claim 18, wherein the electrical components are part of an impedance matching network.

27. The method of claim 18, wherein the performance characteristics enhanced include at least one of gain, frequency response, bandwidth, and loading.

28. The method of claim 18, wherein the electrical components provide the frequency responsive structure with multiband capabilities.

29. The method of claim 18, further comprising tuning a frequency response of the structure by adding material to or subtracting material from the device or performing a combination of adding material to and subtracting material from the device.

30. The method of claim 29, wherein the step of tuning adds material to or subtracts material from the frequency responsive structure or electrical components embedded within the device.

31. The method of claim 29, wherein the step of subtracting includes performing at least one process in a group of subtraction processes including laser trimming, chemical etching, ion beam etching, and scraping.

32. The method of claim 29, wherein the step of adding includes performing at least one process in a group of addition processes including direct writing, screen printing, stamping, lithography, electroplating, wire bonding, conductive gluing, and soldering.

33. The method of claim 18, wherein the step of selecting electrical components comprises selecting electrically adjustable components, and the method further comprises tuning a frequency response of the structure by electrically adjusting the selected components.

34. A method for producing a device including a frequency responsive structure supported on a surface of a substrate, the method comprising the steps of:
selecting electrical components for optimizing performance characteristics of the frequency responsive structure; and
selecting locations on another surface of the substrate, opposite the surface on which the frequency selective structure is supported, for placing the electrical components to optimize performance characteristics of the frequency responsive structure.

35. The method of claim 34, further comprising embedding the selected electrical components at the selected locations on the surface of the substrate opposite the surface of the substrate on which the frequency responsive structure is supported and incorporating the substrate supporting the frequency responsive structure on one surface and the embedded electrical components on the opposite surface into the device.

36. The method of claim 35, wherein the electrical components are embedded within the substrate at the selected locations in a manner that makes the components integral with and contiguous to the substrate.

36. The method of claim 34, wherein the frequency responsive structure comprises a frequency selective surface.

37. The method of claim 35, wherein the step of embedding includes performing at least one process in a group of embedding processes including direct writing, screen printing, stamping, lithography, electroplating, wire bonding, conductive gluing, and soldering.

38. The method of claim 34, wherein the step of selecting electrical components comprises modeling the device with various electrical components embedded therein and determining the electrical components that result in optimal performance characteristics for the frequency responsive structure, and the step of selecting locations for placing the electrical components comprises modeling the device with the electrical components embedded at various locations and determining the locations for placing the electrical components that result in optimal performance characteristics for the frequency responsive structure.

39. The method of claim 38, wherein the steps of modeling are performed using a genetic algorithm.

40. The method of claim 34, wherein the electrical components are part of an impedance matching network.

41. The method of claim 34, wherein the performance characteristics enhanced include at least one of gain, frequency response, bandwidth, and loading.

42. The method of claim 34, wherein the electrical components provide the frequency responsive structure with multiband capabilities.

43. The method of claim 34, further comprising tuning a frequency response of the structure by adding material to or subtracting material from the device or performing a combination of adding material to and subtracting material from the device.

44. The method of claim 43, wherein the step of tuning adds material to or subtracts material from the frequency responsive structure or electrical components embedded within the device.

45. The method of claim 43, wherein the step of subtracting includes performing at least one process in a group of subtraction processes including laser trimming, chemical etching, ion beam etching, and scraping.

46. The method of claim 43, wherein the step of adding includes performing at least one process in a group of addition processes including direct writing, screen printing, stamping, lithography, electroplating, wire bonding, conductive gluing, and soldering.

47. The method of claim 34, wherein the step of selecting electrical components comprises selecting electrically adjustable components, and the method further comprises tuning a frequency response of the structure by electrically adjusting the selected components.

48. A system for producing a device including a frequency responsive structure with optimal performance characteristics, the system comprising:
means for selecting electrical components for embedding as integral and contiguous parts of the device and for optimizing performance characteristics of the structure; and
means for selecting locations within the device for embedding the selected components as integral and contiguous parts of the device and for optimizing performance characteristics of the structure.

49. The system of claim 48, further comprising means for embedding the selected components at the selected locations as contiguous and integral parts of the device.

50. The system of claim 48, wherein the means for selecting locations selects locations within the frequency selective surface for embedding the selected components.

51. The system of claim 50, wherein the frequency responsive structure comprises a pattern of materials, and the system further comprises means for embedding the electrical components within the pattern of materials in a manner that makes the electrical components part of the pattern.

52. The system of claim 48, wherein the frequency responsive structure comprises an antenna.

53. The system of claim 48, wherein the frequency responsive structure comprises a frequency selective surface.

54. The system of claim 48, wherein the components and the locations are selected for embedding using at least one process in a group of contiguous and integrated embedding processes including direct writing, screen printing, stamping, lithography, and electroplating.

55. The system of claim 48, wherein the means for selecting electrical components models the device with various electrical components embedded therein and determines the electrical components that result in optimal performance characteristics, and the means for selecting locations for placing the electrical components models the device with electrical components embedded at various locations and determines the locations for placing the electrical components that result in optimal performance characteristics.

56. The system of claim 55, wherein the modeling is performed using a genetic algorithm.

57. The system of claim 48, wherein the electrical components are part of an impedance matching network.

58. The method of claim 48, wherein the performance characteristics enhanced include at least one of gain, frequency response, bandwidth, and loading.

59. The system of claim 48, wherein the electrical components provide the frequency responsive structure with multiband capabilities.

60. The system of claim 48, further comprising means for tuning a frequency response of the structure by adding material to or subtracting material from the device or performing a combination of adding material to and subtracting material from the device.

61. The system of claim 60, wherein the tuning means adds material to or subtracts material from the frequency responsive structure or electrical components embedded within the device.

62. The system of claim 60, wherein the subtracting means includes means for performing at least one process in a group of subtraction processes including laser trimming, chemical etching, ion beam etching, and scraping.

63. The system of claim 60, wherein the adding means includes means for performing at least one process in a group of addition processes including direct writing, screen printing, stamping, lithography, electroplating, wire bonding, conductive gluing, and soldering.

64. The system of claim 48, wherein the means for selecting electrical components selects electrically adjustable components, and the system further comprises means for tuning a frequency response of the structure by electrically adjusting the selected components.

65. A system for producing a device including a frequency responsive structure with optimal performance characteristics, the system comprising:
means for selecting electrical components for optimizing performance characteristics of the frequency responsive structure;
means for selecting locations within the device for placing the selected components for optimizing performance characteristics of the structure; and
means for producing the device, including the frequency responsive structure and the selected electrical components placed at the selected locations,
wherein the frequency responsive structure and the selected electrical components are formed in the same manufacturing process.

66. The system of claim 65, wherein the frequency responsive structure comprises a pattern of materials with the selected electrical components embedded therein.

67. The system of claim 65, wherein the frequency responsive structure is supported by one surface of a substrate included in the device, and the electrical components are supported by another surface of the substrate.

68. The system of claim 65, wherein the frequency responsive structure comprises an antenna.

69. The system of claim 65, wherein the frequency responsive structure comprises a frequency selective surface.

70. The system of claim 65, wherein the means for producing the device performs at least one process in a group of contiguous and integrated manufacturing processes including direct writing, screen printing, stamping, lithography, and electroplating.

71. The system of claim 65, wherein the means for selecting electrical components models the device with various electrical components included therein and determines the electrical components that result in optimal performance characteristics, and the means for selecting locations for placing the electrical components models the device with electrical components placed at various locations therein and determines the locations for placing the electrical components that result in optimal performance characteristics.

72. The system of claim 71, wherein the modeling is performed using a genetic algorithm.

73. The system of claim 65, wherein the electrical components are part of an impedance matching network.

74. The system of claim 65, wherein the performance characteristics enhanced include at least one of gain, frequency response, bandwidth, and loading.

75. The system of claim 65, wherein the electrical components provide the frequency responsive structure with multiband capabilities.

76. The system of claim 65, further comprising means for tuning a frequency response of the structure by adding material to or subtracting material from the device or performing a combination of adding material to and subtracting material from the electrical components within the device.

77. The system of claim 76, wherein the tuning means adds material to or subtracts material from the frequency responsive structure or electrical components embedded within the device.

78. The system of claim 76, wherein the subtracting means includes means for performing at least one process in a group of subtraction processes including laser trimming, chemical etching, ion beam etching, and scraping.

79. The system of claim 76, wherein the adding means includes means for performing at least one process in a group of addition processes including direct writing, screen printing, stamping, lithography, electroplating, wire bonding, and conductive gluing.

80. The system of claim 65, wherein the means for selecting electrical components selects electrically adjustable components, and the system further comprises means for tuning a frequency response of the structure by electrically adjusting the selected components.

81. A system for producing a device including a frequency responsive structure supported on a surface of a substrate, the system comprising:
means for selecting electrical components for optimizing performance characteristics of the frequency responsive structure; and
means for selecting locations on another surface of the substrate, opposite the surface on which the frequency selective structure is supported, for placing the electrical components to optimize performance characteristics of the frequency responsive structure.

82. The system of claim 81, further comprising means for embedding the selected electrical components at the selected locations on the surface of the substrate opposite the surface of the substrate on which the frequency responsive structure is supported and means for incorporating the substrate supporting the frequency responsive structure on one surface and the embedded electrical components on the opposite surface into the device.

83. The system of claim 81, wherein the electrical components are embedded within the substrate at the selected locations in a manner that makes the components integral with and contiguous to the substrate.

84. The system of claim 81, wherein the frequency responsive structure comprises a frequency selective surface.

85. The system of claim 82, wherein the embedding means includes means for performing at least one process in a group of embedding processes including direct writing, screen printing, stamping, lithography, electroplating, wire bonding, and conductive gluing.

86. The system of claim 81, wherein the means for selecting electrical components models the device with various electrical components embedded therein and determines the electrical components that result in optimal performance characteristics for the frequency responsive structure, and the means for selecting locations for placing the electrical components comprises models the device with the electrical components embedded at various locations and determines the locations for placing the electrical components that result in optimal performance characteristics for the frequency responsive structure.

87. The system of claim 86, wherein the modeling is performed using a genetic algorithm.

88. The system of claim 81, wherein the electrical components are part of an impedance matching network.

89. The system of claim 81, wherein the performance characteristics enhanced include at least one of gain, frequency response, bandwidth, and loading.

90. The system of claim 81, wherein the electrical components provide the frequency responsive structure with multiband capabilities.

91. The system of claim 81, further comprising means for tuning a frequency response of the structure by adding material to or subtracting material from the device or performing a combination of adding material to and subtracting material from the device.

92. The system of claim 91, wherein the tuning means adds material to or subtracting material from the frequency responsive structure or electrical components embedded within the device.

93. The system of claim 91, wherein the subtracting means includes means for performing at least one process in a group of subtraction processes including laser trimming, chemical etching, ion beam etching, and scraping.

94. The system of claim 91, wherein the adding means includes mean for performing at least one process in a group of addition processes including direct writing, screen printing, stamping, lithography, electroplating, wire bonding, conductive gluing, and soldering.

95. The system of claim 81, wherein the means for selecting electrical components selects electrically adjustable components, and the system further comprises means for tuning a frequency response of the structure by electrically adjusting the selected components.
